(19) United States
(12) Patent Application Publication
(10) Pub. No.: US 2005/0220406 A1
(43) Pub. Date: Oct. 6, 2005

(54) Athermal bragg grating

(76) Inventors: Richard Jones, Santa Clara, CA (US); Oded Cohen, Gedera (IL); Ling Liao, Santa Clara, CA (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/813,637

(22) Filed: Mar. 31, 2004

(51) Int. Cl. G02B 6/34; G02B 6/10

(52) U.S. Cl. 385/37; 385/14; 385/15; 385/31; 385/129; 385/130; 385/132

(57) ABSTRACT

Embodiments of the invention describe a silicon oxynitride Bragg grating disposed in a semiconductive layer on an insulating substrate. The grating may be formed of alternating silicon oxynitride elements that differ in a relative composition of oxygen and nitrogen. The different composition elements have different refractive indices that may vary within a desired range.

### BACKGROUND OF THE INVENTION

Optical communication systems often make use of Bragg gratings in various capacities. Among other uses, Bragg gratings can function as transmission or reflection filters and as components of multiplexers/demultiplexers in wavelength division multiplexing (WDM) communication systems. They are also useful in external cavity laser (ECL) applications, and may provide a means of stabilizing the spectra produced by the laser cavity.

When using a Bragg grating in an optical communication system, it is important that the refractive indices of the grating be maintained at stable and known values. Unfortunately, this requirement is often difficult to satisfy at a low cost. Although Silicon on Insulator (SOI) Bragg gratings are relatively simple and inexpensive to manufacture, and may be activated by current injection, e.g., in active devices, they are also very sensitive to temperature. For example, a change of about 100° C. may induce a change of about 0.02 in the refractive index of silicon, and this change may cause a shift of approximately 12 nm in the stop band position of a 4 μm period SOI Bragg grating. Maintaining such a silicon grating at constant temperature requires relatively high power and additional fabrication complexity that may significantly increase the cost of fabrication and operation of the device. Other gratings, for example, gratings using silica (SiO₂), are difficult to integrate with silicon waveguides and are characterized by a limited refractive index contrast, which limits the spectral characteristics that may be achieved by devices incorporating such gratings.

### BRIEF DESCRIPTION OF THE DRAWINGS

The subject matter regarded as the invention is particularly pointed out and distinctly claimed in the concluding portion of the specification. The invention, however, both as to organization and method of operation, as well to features and advantages thereof, may best be understood by reference to the following detailed description when read with the accompanied drawings in which:

FIG. 1 is a schematic block diagram of an optical communication system according to exemplary embodiments of the invention

FIG. 2 is a schematic diagram of a SiON grating on SOI according to an exemplary embodiment of the invention;

FIGS. 3A, 4A, 5A, and 6A are top view schematic illustrations of various stages in a process of fabrication of a SiON grating on SOI according to an exemplary embodiment of the invention;

FIGS. 3B, 4B, 5B and 6B are schematic side view, cross-sectional, illustrations of the process stages shown in FIGS. 3A, 4A, 5A, and 6A, respectively, taken along section lines B-B;

FIGS. 3C, 4C, 5C and 6C are schematic side view, cross-sectional, illustrations of the process stages shown in FIGS. 3A, 4A, 5A, and 6A, respectively, taken along section lines C-C; and

FIG. 7 is a schematic top-view illustration of a fixed wavelength transponder including a SiON Bragg grating according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

It will be appreciated that the terms “top” and “bottom” may be used herein for exemplary purposes only, to illustrate the relative positioning or placement of certain components, and/or to indicate a first and a second component. The terms “top” and “bottom” as used herein do not necessarily indicate that a “top” component is above a “bottom” component, as such directions and/or components may be flipped, rotated, moved in space, placed in a diagonal orientation or position, placed horizontally or vertically, or similarly modified.

It should be understood that the scope of the present invention is not limited by the exemplary embodiments and fabrication processes detailed in the following. Embodiments of the present invention may be fabricated from a variety of materials, forming a variety of structures, and using a variety of processes and procedures.

It should be understood that the present invention may be used in a variety of applications. Although the present invention is not limited in this respect, the semi conductor devices and techniques disclosed herein may be used in many apparatuses such as optical communication systems. Systems intended to be included within the scope of the present invention include, by way of example only, optical local area networks (LAN), metropolitan area networks (MAN) and enterprise networks. Optical communication devices intended to be included within the scope of the present invention include, by way of example only, external cavity lasers, transponders, switches, add-drop multiplexers, demultiplexers, receivers and the like.

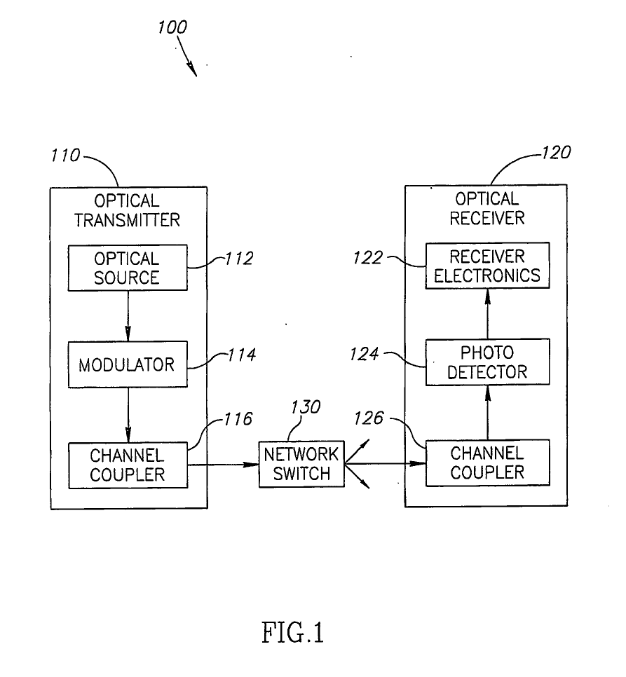

Turning first to FIG. 1, an optical communication system 100, for example, a data communication system, in accordance with exemplary embodiments of the invention, is shown. Although the scope of the present invention is not limited in this respect, the exemplary optical communication system 100 may include at least one optical transmitter 110, at least one optical receiver 120 and at least one network switch 130, as is known in the art. Although not limited in this respect, optical transmitter 110 may include optical communication components such as, for example, an optical signal source 112, an optical signal modulator 114, and a channel coupler 116. Optical receiver 120 may include receiver electronics 122, a photo detector 124 and a channel coupler 126. One or more components of transmitter 110 and/or receiver 120, for example coupler 116 of transmitter 110 and/or coupler 126 of receiver 120, may include a Bragg grating to perform a desired optical function on optical signals transmitted by transmitter 110 and/or received by receiver 120, respectively. The one or more Bragg gratings incorporated in optical communication system 100 may include an athermal grating, for example a SiON on SOI Bragg grating, according to exemplary embodiments of the present invention, as described in detail below.

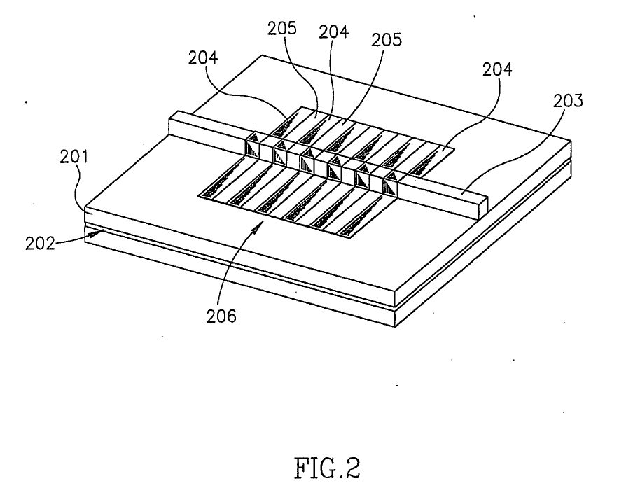

Turning to FIG. 2, a schematic diagram of an exemplary embodiment of a SiON on SOI Bragg grating is shown. The bottom of the device includes a silicon platform 201 disposed over an insulating silicon dioxide (SiO₂) layer 202. A rib silicon wave-guide 203 that may be, for example, of a width of 3 μm and depth of 4 μm may be disposed along the top of the Silicon platform. Along a finite section of the wave guide the silicon may be replaced by a grating composed of periodically alternating elements 204 and 205. The alternating elements 204 and 205 may be composed of two different compositions of silicon oxynitride, which elements may be referred to herein as SiON-1 elements and SiON-2 elements, respectively. For example, the silicon oxynitride composition of SiON-1 may be SiO₂ and the silicon oxynitride composition of SiON-2 may be Si₃N₄. In this example, the refractive index of the different SiON elements may alternate between approximately 1.44 (SiO₂) and approximately 2 (Si₃N₄). The alternating elements 204 and 205 of SiON-1 and SiON-2 form a SiON Bragg grating 206 in the rib waveguide 203.

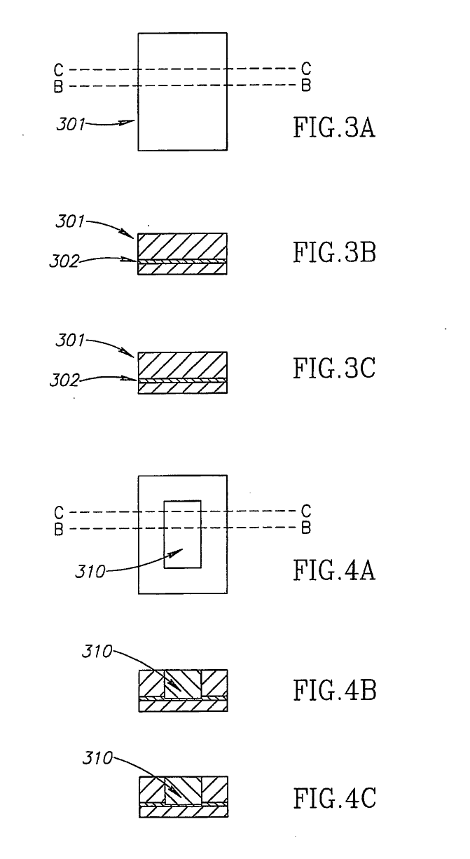

The width of the alternating SiON-1/SiON-2 (204/205) Bragg grating 206 may be, for example, of the order of 50 μm. As discussed in detail below with reference to FIG. 3, the SiON Bragg grating 206 may extend all the way down to the SiO₂ layer 202, below the silicon platform 201. Thus the cross-sectional area of grating 206 which may be much larger than the width of an optical signal intended for use with such waveguides (e.g., less than about 5 μm), and which may be much larger than the cross sectional width of the rib SOI waveguide 203, which may be on the order of, for example, 15 μm², may prevent an optical signal in the grating from “leaking” to the surrounding silicon platform 201.

It should be noted that controlling the variation in composition of the alternating elements 204 and 205 of grating 206 may control a respective variation in refractive index. Possible variations in refractive index may be as small as 10⁻³ or as large as 0.56, in terms of absolute values. These variations are significantly larger than those achievable with conventional Bragg gratings, which may be limited to a refractive index variation on the order of 10⁻³.

It will be appreciated by persons skilled in the art that silicon oxynitride compositions of the present invention may have the advantage of a significantly reduced thermo-optic coefficient, for example, Δn/ΔT˜1.2×10-5/° C., which may significantly improve, e.g., by an order of magnitude, the temperature stability of devices using Bragg gratings according to the invention. For example, devices according to some embodiments of the invention may exhibit a dramatically reduced wavelength shift, e.g., a wavelength shift on the order of 1 nm/100° C., although the invention is not limited in this respect.

In some embodiments, the SiON grating may be placed in an otherwise conductive silicon waveguide. In such embodiments, the entire waveguide may also be used as an active device, for example, by use of current injection, as discussed below.

Turning to FIGS. 3-6, a process flow diagram of an exemplary process of fabricating a SiON grating on a SOI substrate is illustrated. FIG. 3A shows a top view of a semiconductor structure 300 to be fabricated to include a Bragg grating according to embodiments of the invention, and FIGS. 3B and 3C show two cross sectional side views of structure 300 taken along section lines B-B and C-C, respectively. Although not limited in this respect, fabrication may begin with a silicon platform 301, covering a silicon oxide (SiO₂) layer 302. The depth of the silicon platform 301 may be, for example, on the order of 4 μm and its width may be, for example, on the order of 30 cm.

FIGS. 4A-4C show the next stage in the exemplary fabrication process. A trench 310, for example, having a width on the order of 50 μm, and a length according to the length of the Bragg grating to be formed, e.g. 4 mm, may be etched into the silicon layer, extending down to the insulating oxide layer. Trench 310 may be subsequently filled with a single component silicon oxynitride, e.g. for example SiON-1, and chemically and mechanically polished (CMP), resulting in the structure shown in the top view of FIG. 4A. FIG. 4B and FIG. 4C show two cross sectional side views of the structure of FIG. 4A taken along section lines B-B and C-C, respectively. It should be understood that the shape and dimensions described above for trench 310 are but one exemplary embodiment of the present invention, and that the scope of the invention is not limited to these shapes and dimensions. In other embodiments of the invention, trench 310 may be constructed to have various other exemplary shapes and dimensions, for example, a non-rectangular parallelogram shape of desired dimensions, in accordance with specific implementations and design requirements.

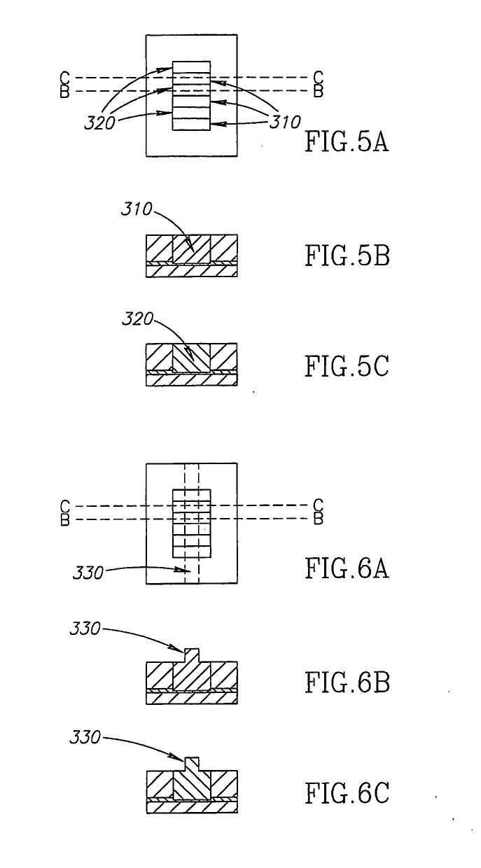

The next stage in the exemplary fabrication process is shown in FIGS. 5A-5C. Trenches 320 of a width and periodicity according to the periodicity of the Bragg grating to be formed, for example, 3 μm wide, may be etched into the single component silicon oxynitride trench 310, perpendicular to the direction of the grating to be formed. These trenches may be filled with a second silicon oxynitride, e.g. SiON-2, for example a silicon oxynitride with a different composition and refractive index from that of SiON-1, as described above. The filled trenches may be chemically and mechanically polished resulting in the form shown in the top view of FIG. 5A. FIG. 5B and FIG. 5C show two cross sectional side views of the structure of FIG. 5A taken along section lines B-B and C-C, respectively.

FIGS. 6A-6C show a final stage in the exemplary production process. A rib, 330, for example 3 μm wide, may be etched along the direction of the waveguide grating to be formed. A low temperature oxide (LTO) layer may be deposited as a top cladding, resulting in the structure shown in the top view of FIG. 6A. FIG. 6B and FIG. 6C show two cross sectional side views of the structure of FIG. 6A taken along section lines B-B and C-C, respectively.

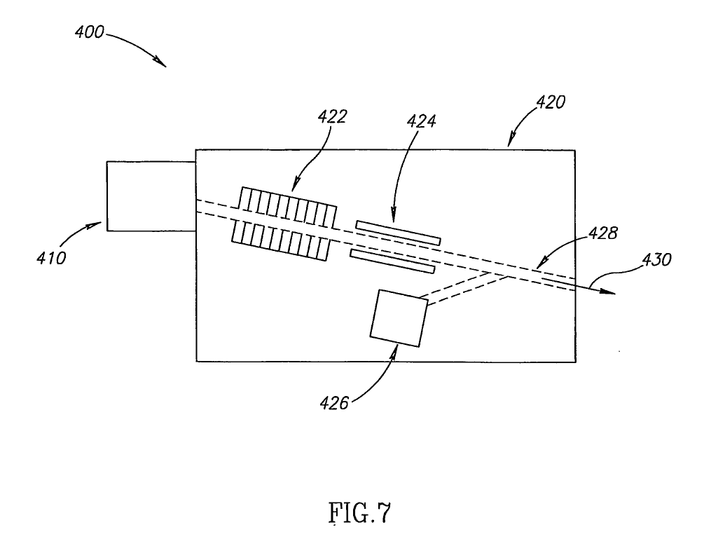

Turning to FIG. 7, a schematic top-view illustration of an external cavity laser device, e.g. a fixed wavelength transponder, including a SiON Bragg grating according to exemplary embodiments of the invention is shown. The device of FIG. 7 illustrates one exemplary embodiment of an optical arrangement including a Bragg grating according to embodiments of the invention; other optical arrangements are also within the scope of the present invention. The device may be composed of at least two main blocks, a laser source, for example, a red indium phosphate gain chip 410, and a SOI block 420. An anti-reflective coated interface between the gain chip 410 and block 420 enables an optical signal from gain chip 410 to enter a rib SOI waveguide 428 disposed on block 420. Along waveguide 428 there may be a SiON Bragg grating 422, e.g., according to the exemplary embodiment shown in FIG. 2 that may be fabricated, e.g., according to the exemplary method described in FIGS. 3-6. Bragg grating 422 may act as a mirror to the laser source 410. The region between laser source 410 and Bragg grating 422 may operate as an external laser cavity. Downstream from Bragg grating 422 there may be a SOI current injection modulator 424 and, further downstream, a Germanium doped silicon block, 426, which may function as a power monitor. An optical signal generated by gain chip 410 and modulated along waveguide 428 may then pass into an optical fiber 430 for transmission.

It should be noted that block 420, which may incorporate the SiON Bragg grating within a SOI waveguide on a single SOI substrate, may benefit from the attributes of both types of materials, i.e., the athermal SiON Bragg grating may be used to stabilize the frequency of the external cavity laser, and the conductive properties of the SOI waveguide may be used for current injection modulation of a signal.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus comprising:
a Bragg grating formed in a semiconductive layer attached to an insulating substrate, the Bragg grating comprising:
a plurality of elements of a first substantially electrically insulating material; and
a plurality of elements of a second substantially electrically insulating material alternating with the elements of said first substantially insulating material.

2. An apparatus according to claim 1, wherein at least some of the first and second alternating elements are substantially in contact with the insulating substrate.

3. An apparatus according to claim I wherein the first and second electrically insulting materials comprise first and second, different, types of silicon oxynitride.

4. An apparatus according to claim 3 wherein the first and second different types of silicon oxynitride differ in a relative composition of oxygen and nitrogen.

5. An apparatus according to claim 1 comprising:
a rib waveguide etched in the semiconductive layer in a direction substantially perpendicular to interfaces between the first and second elements of the Bragg grating.

6. A method comprising:
guiding an optical signal; and
performing an optical function on said optical signal using an optical arrangement comprising a Bragg grating having a plurality of alternating elements of first and second, different, substantially electrically insulating materials formed in a semiconductive layer attached to an insulating substrate.

7. A method according to claim 6 wherein performing an optical function comprises:
oscillating said optical signal at a desired frequency.

8. A method according to claim 6 wherein performing an optical function comprises:
reflecting said optical signal.

9. A method according to claim 6 wherein performing an optical function comprises:
filtering said optical signal.

10. A method according to claim 6, wherein the first and second electrically insulting materials comprise first and second, respective, types of silicon oxynitride having first and second, different, compositions of oxygen and nitrogen.

11. An external cavity laser device comprising:
a laser source; and
an external laser cavity defined between said laser source and a Bragg grating formed in a semiconductive layer attached to an insulating substrate, the Bragg grating comprising a plurality of alternating elements of first and second, different, substantially electrically insulating materials,
wherein said external laser cavity is able to oscillate an optical signal generated by said laser source at a substantially fixed frequency determined by the structure of said Bragg grating.

12. An external cavity laser device according to claim 11 wherein at least some of the first and second alternating elements are substantially in contact with the insulating substrate.

13. An external cavity laser device according to claim 12 wherein the first and second electrically insulting materials comprise first and second, different, types of silicon oxynitride.

14. An external cavity laser device according to claim 13 wherein the first and second different types of silicon oxynitride differ in a relative composition of oxygen and nitrogen.

15. An external cavity laser device according to claim 11 comprising a rib waveguide etched in the semiconductive layer in a direction substantially perpendicular to interfaces between the first and second elements of the Bragg grating.

16. An external cavity laser device according to claim 11 further comprising a current injection modulator to modulate an optical signal generated by said laser source.

17. An external cavity laser device according to claim 16 further comprising a power monitor to monitor power of said optical signal.

18. An external cavity laser device according to claim 17 further comprising an optical fiber to transmit said optical signal.

19. An optical system comprising:
an optical transmitter to transmit optical signals;
an optical receiver to receive said optical signals; and
an optical switch on a path of light between said transmitter and said receiver,
wherein at least one of said transmitter and said receiver includes an optical component comprising a Bragg grating formed in a semiconductive layer attached to an insulating substrate and wherein the Bragg grating comprises a plurality of alternating elements of first and second, different, substantially electrically insulating, materials.

20. An optical system according to claim 19 wherein said optical component comprises an optical coupler.

21. An optical system according to claim 19 wherein at least some of the first and second alternating elements are substantially in contact with the insulating substrate.

22. An apparatus according to claim 19 wherein the first and second electrically insulting materials comprise first and second, different, types of silicon oxynitride having first and second, respective, relative compositions of oxygen and nitrogen.

23. An apparatus according to claim 19 comprising:
a rib waveguide etched in the semiconductive layer in a direction substantially perpendicular to interfaces between the first and second elements of the Bragg grating.
